(19) United States
(12) Patent Application Publication
(10) Pub. No.: US 2007/0141316 A1
(43) Pub. Date: Jun. 21, 2007

(54) Tri-extruded WUCS glass fiber reinforced plastic composite articles and methods for making such articles

(76) Inventors: Ralph D. McGrath, Granville, OH (US); Mike A. Strait, Johnstown, OH (US); Kevin S. Guigley, Granville, OH (US); Douglas H. Walden, Newark, OH (US); Teresa L. Wagner, Granville, OH (US); Ashish P. Diwanji, Northville, MI (US)

Correspondence Address: OWENS CORNING, 2790 COLUMBUS ROAD, GRANVILLE, OH, 43023, US

(21) Appl. No.: 11/311,749

(22) Filed: Dec. 19, 2005

(51) Int. Cl. B29C 47/06; D04H 13/00

(52) U.S. Cl. 428/292.1; 264/173.16; 428/304.4

(57) ABSTRACT

Disclosed are a series of composite polymer composite structures formed by the coextrusion of at least two distinct polymeric compositions including a structural composition and a coating composition whereby the primary structural frame formed from the structural composition includes at least one, and typically a plurality, of longitudinal recesses or cavities. These recesses or cavities may, in turn, be filled with a third distinct polymeric composition that may include wood byproducts and/or a foaming or blowing agent.

### TECHNICAL FIELD AND INDUSTRIAL APPLICABILITY

This invention relates to methods of forming or molding reinforced and unreinforced composite articles including one or more virgin or recycled polymers and a fibrous component, typically including a combination of natural fibers, for example wood and/or other cellulosic fibers, synthetic polymeric fibers and inorganic fibers such as glass or other mineral fibers. The various fibers can be introduced into the composite article using various techniques including, for example, in masterbatch polymeric compositions, as dry use chopped strand (DUCS) glass fibers or as wet use chopped strand (WUCS) glass fibers.

Depending on intended application for the final product, the composite articles may also include one or more fillers, for example, calcium carbonate, talc, magnesium hydroxide, magnesium silicate, calcium oxide, clay, glass and gypsum, and/or other specific functional components or additives for modifying the structural properties, mechanical performance, fire properties, mold and mildew resistance, weatherability, and/or appearance of the composite material and/or the resulting products. This invention also relates to reinforced and unreinforced composite products that incorporate regions of reduced density materials and methods for achieving such reductions in the natural density of one or more of the materials used in forming the composites including, for example, the use of various chemical and gaseous infusion methods and/or the use of certain lightweight fillers.

### BACKGROUND OF THE INVENTION

Wood fibers, especially fibers from waste wood generated during the production of dimensional lumber, milling or shaping of wood substrates, in combination with one or more polymeric adhesives, have long been used in the production of composite materials such as oriented strand board (OSB) and particleboard. OSB products, for example, can be manufactured by combining wood fibers with urea, phenol and melamine resin binders to form an intermediate product. This intermediate product is then subjected to relatively high pressures and/or temperatures to compress and cure the mixture to obtain the final OSB product. This process, therefore, while generally suitable for forming large planar sheets, is less suitable for forming composite products having complex profiles and/or otherwise formed portions.

Further, the wood fiber or strand thickness and length ranges typically utilized in producing OSB products are generally less suitable for products intended for applications in which mechanical forces must be transmitted more uniformly throughout the composite product. Indeed, the variations in the diameter and length of the wood fibers incorporated into the OSB products tend to produce regions of high pressure and low pressure that render such products generally unsuitable for articles subjected to bending stresses.

Particleboard is manufactured using a process similar to that used to manufacture OSB but, rather than using wood fibers or stands, particleboard is manufactured using fine wood particles as its main structural component. The use of the conventional binders and/or adhesives similar to those used in the manufacture of OSB, typically requires the application of very high pressures and an elevated temperature to compress and cure the mixture to produce the final product. The structural limitations associated with particleboard, particularly its reduced strength relative to corresponding thicknesses of OSB and plywood products, its tendency to absorb water and its increased density render it unsuitable for many applications, particularly exposed applications or those in which significant loads are anticipated.

Other methods have been developed to utilize wood fiber in making shaped articles having drawn portions, such as pallets, rather than more planar articles such as decking or sheeting. Such pallets typically include a flat support surface with a plurality of projections extending below the support surface for contacting the floor or shelving on which the pallet is placed. Such pallets are typically manufactures from a variety of wood fibers, particularly those typically found in paper mill effluent streams, usually in combination with one or more filler materials, for example clay, and/or longer wood fibers from one or more secondary sources. The wood fibers are typically bonded using one or more thermosetting resins, for example phenolformaldehyde, resorcinol-formaldehyde, melamine-formaldehyde, urea-formaldehyde, urea-furfural and condensed furfuryl alcohol resin and organic polyisocyanates.

The bonding performance of isocyanates in particular can be highly dependent upon the density and porosity of the bonded materials. When isocyanates are utilized, therefore, a preferred practice is to limit the size and density distribution within the mixture of wood fibers that are being processed into the drawn articles. This limitation can result in an acute disadvantage in systems that obtain waste wood from many different sources. The use of these isocyanate binding agents may also raise environmental and workplace safety issues. These compositions also tend to exhibit only limited moisture protection and do not tend to exhibit uniform strength characteristics throughout their load bearing portions.

Molded pallets and platforms may also incorporate one or more plastic compositions, typically either as a coating applied over a wood or cellulosic fiber matrix or as an additive to a wood pulp slurry. While the products produced by incorporating one or more plastics may exhibit improved moisture resistance, such articles continue to suffer from either the strength limitations referenced above or by requiring an intricate and complex forming process. In some situations, plastic is added only as a coating in the final forming stages of the article, and thus does not tend to impart significant bonding, strength, and other desirable characteristics that can be achieved when appropriate plastic formulations are utilized in composite products as a primary structural component and/or as a bonding agent.

Additionally, the conventional methods which utilize wood fibers in some capacity to form a finished composite article do not tend to utilize the waste wood supply in any substantive manner, with portions of the waste wood typically being incinerated, used as fuel in an electrical cogeneration facility or buried in a landfill. Many of the conventional methods utilize either paper mill sludge as a source for wood fibers or are resigned to being dependent on the arrival of a sufficient raw wood supply which is consistent in the same type of wood utilized previously utilized.

Other efforts to produce composite structural materials incorporating waste wood involves combining the cellulosic fibers from the waste wood with particles of one or more plastics such as high density polyethylene (HDPE) or low density polyethylene (LDPE) to form a composite mixture. The length of fiber or flake and the type of plastic selected are dependent upon the material characteristics desired in the finished product. A coupling agent may be added to the mixture as the cellulosic fibers and the plastic(s) are being blended together, thereby enhancing the intended properties in the finished article.

This composite material mixture may then be deposited onto a mold to form a mat or charge of the composite material on the mold. Depending on the manner in which the composite material is applied to the mold, some control over the fiber orientation within the mold. The composite material mixture is then typically subjected to a combination of heat and pressure sufficient to force the plastic throughout the fibers to fill substantially all voids and interstices.

### SUMMARY OF THE INVENTION

Provided are a number of exemplary processes and manufacturing methods for producing a range of products that feature multiple combinations of reinforced and unreinforced, filled and unfilled, foamed and unfoamed, composite materials that have been configured to incorporate at least two and typically at least three different polymeric compositions. The use of these multiple and distinct polymeric composites in various combinations allows the physical properties and configuration of the individual elements and their associated polymer composite to be better tailored to meet desired structural, aesthetic and durability parameters.

Composite articles, particularly wood plastic composite (“WPC”) articles, according to the invention may be configured to provide benefits including one or more of improved performance, reduced cost, increased profit and generally improved economics for complete material systems. It is anticipated that the final products manufactured and/or configured according to the disclosure provided below will have particular utility for building decks, railings and other exposed structures, as well as a broad range of other building products and applications detailed herein.

The invention encompasses methods of manufacturing a reinforced composite article that includes preparing a first composition including a first polymeric component and a first reinforcing component; preparing a second composition including a second polymeric component; and preparing a third composition including a third polymeric component and an additive. These compositions are then coextruded to produce a composite article having distinct components or regions formed from each of the first, second and third compositions. Within the composite article, the first composition is used to form a primary structural frame having at least one longitudinal cavity, i.e., a channel or recess extending in the extrusion direction, with the second composition substantially filling the first longitudinal cavity and the third composition forming a surface layer on at least one major surface of the composite article.

As used herein, the term coextrusion encompasses both extrusion processes involving disparate materials that are extruded simultaneously using a single die and extrusion processes in which the disparate materials are extruded in a substantially simultaneous, but serial, manner using a closely spaced series of two or more complementary dies.

The first composition, and optionally the second and third compositions, may include one or more reinforcing materials, for example fiberglass and particularly fiberglass incorporated in a wet use chopped strand (WUCS) form having a moisture content of more than about 5%. To the extent that one or more of the components of a composition include residual water, a moisture scavenger, for example gypsum particles, may also be included in sufficient quantity to bind or remove a sufficient amount of water to avoid substantial moisture related degradation.

The second composition may include one or more fillers selected from the group consisting of wood flour, wood particles, wood fibers, calcium carbonate, talc, magnesium hydroxide and gypsum; and the third composition may include one or more additives selected from a group consisting of UV stabilizers, color stabilizers, IR reflectors, fire retardants, smoke suppressors, lubricants, lubricants, wear resistors, friction modifiers, pigments and dyes. The second composition may also include one or more blowing agents or a blowing system that will cause the second composition to expand and create a foam as it is extruded to fill one or more longitudinal cavities.

The surface layer formed with the third polymeric composition may be subjected to further processing intended to alter the appearance and/or surface profile of the surface layer. Such processing can include one or more processes including, for example, introducing foreign material into or onto an exterior portion of the surface layer and/or stamping, rolling, milling or otherwise machining at least an exterior portion of the surface layer to alter the surface profile in the extrusion or machine direction and/or at some other angle, angles or varying angles relative to the extrusion direction.

The foreign material may include one or more components selected from a group consisting of wood fibers, wood particles, wood flour, natural fibers, clay, fillers, polyolefins, copolymers, glass fibers, mineral fibers, dyes, pigments and colorants. Depending on the materials selected and the manner in which they are incorporated into the surface layer, various patterns applied to or formed in the surface layer, the foreign material and/or the additional surface processing may be used to form an elongated pattern of alternating light and dark colored regions in a manner simulating a natural wood grain appearance and may incorporate matching surface texture for enhancing the simulation.

The invention also includes methods of manufacturing composite articles including preparing a structural composition including a first polymeric component and a first reinforcing component; preparing a coating composition including a second polymeric component and an additive; coextruding the structural composition and the coating composition to form a composite product including a primary structural frame formed from the structural composition with the coating composition being provided as a layer on at least a major surface of the primary structural frame. The primary structural frame can include one or more longitudinal cavities, some or all of which may be filled with a filling composition such as a polymeric foam or a highly filled polymeric material.

The invention also includes methods of manufacturing composite articles including preparing a structural composition including a first polymeric component and a first reinforcing component; a second composition including a second polymeric component and a third composition including a third polymeric component and an additive; coextruding the first, second and third compositions to form a composite article in which the first composition forms a primary structural element that is encompassed by a polymeric foam formed from the second composition and the third composition forms a surface layer on a major surface of the polymeric foam.

The first reinforcing component may be fiberglass, particularly WUCS fiberglass, the second composition may include one or more fillers selected from the group consisting of wood flour, wood fibers, calcium carbonate, talc, magnesium hydroxide and gypsum and the additive will includes at least one component selected from a group consisting of UV stabilizers, color stabilizers, IR reflectors, fire retardants, smoke suppressors, lubricants, pigments and dyes. As will be appreciated, some additives, particularly colorants and/or pigments may be included in each of the composition in quantities sufficient to provide an acceptably narrow range of coloration on an exposed cross-sectional surface of the composite article.

Depending on the intended final application(s), it is preferred that the structural integrity and flame resistance of the composition article be sufficient that the composite article can pass one or more qualification tests promulgated by one or more national or international standards organization such as the American National Standards Institute (ANSI), the American Society for Testing and Materials (ASTM), the Engineered Wood Association (EWA), the British Standards Institutions (BSI), the Building and Fire Research Laboratory (BFRL), the Canadian Standards Association (CSA), the Canadian Wood Council (CWC), the National Association of Home Builders (NAHB), the National Fire Protection Association (NFPA), the National Institute for Standards and Technology (NIST) and/or Underwriters Laboratories, Inc. (UL) and/or the corresponding state and regional organizations.

As will be appreciated, it is preferred that the various compositions incorporated in reinforced composite articles be selected and formulated in a manner that provides a cross-sectional surface and/or outer surface that generally avoids obvious differences in texture and/or coloration. Accordingly, if the second polymeric composition is a polymeric foam, it is preferred that the average cell size be relatively fine, thereby avoiding a sponge-like appearance and, if the foam component forms a portion of the exterior surface of the composite article, that the composition be formulated to form a “skin” or surface layer that does not include any open cells to present a more “solid”

Other features and advantages of the invention will become apparent upon reading the following specification of representative embodiments in conjunction with the accompanying drawing figures.

### BRIEF DESCRIPTION OF THE DRAWINGS

The features and operation of the invention will be apparent from the following more detailed description of various embodiments of the invention and as illustrated in the accompanying drawings. These drawings are provided for illustrative purposes only and are not drawn to scale. The spatial relationships and relative sizing of the elements illustrated in the various embodiments may have been reduced, expanded or rearranged to improve the clarity of the figure with respect to the corresponding description. The figures, therefore, should not be interpreted as accurately reflecting the relative sizing or positioning of the corresponding structural elements that could be encompassed by the example embodiments of the invention.

FIG. 1 is a schematic representation of process equipment arranged to support the process for manufacturing flow according to an embodiment of the invention.

FIGS. 2A-2C are representative cross-sections of various embodiments of the composite product as manufactured on the equipment illustrated in FIG. 1, along planes A-A, B-B and C-C respectively, according to embodiments of the invention.

FIGS. 2D-2F are representative cross-sections of the composite product that may be manufactured on the equipment illustrated in FIG. 1, along plane C-C, according to an embodiment of the invention.

FIG. 3 is a schematic representation of process equipment arranged to support the process for manufacturing flow according to another embodiment of the invention.

FIGS. 4A-4C are representative cross-sections of the composite product that may be manufactured on the equipment illustrated in FIG. 3, along planes A-A, B-B and C-C respectively, according to another embodiment of the invention.

FIGS. 4D is a representative cross-section of a composite product that may be manufactured on the equipment illustrated in FIG. 3, along plane C-C, according to another embodiment of the invention.

FIG. 5 is a schematic representation of process equipment arranged to support the process for manufacturing flow according to another embodiment of the invention.

FIGS. 6A-6E are representative cross-sections of the composite product that may be manufactured on the equipment illustrated in FIG. 5, along plane A-A (FIG. 6A) and along plane B-B (FIGS. 6B-6E) according to another embodiment of the invention.

FIG. 7 is a schematic representation of process equipment arranged to support the process for manufacturing flow according to another embodiment of the invention.

FIGS. 8A-8D are representative cross-sectional and plan views of various embodiments of composite articles manufactured according to embodiments of the invention illustrating surface finishing treatments.

FIGS. 9A-9E are representative cross-sectional views of various embodiments of composite articles manufactured according to embodiments of the invention.

The examples discussed below and/or illustrated in the patent drawings are provided so that this disclosure will be thorough and complete, and will fully convey the scope of the invention to those skilled in the art. The principles and features of this invention may be employed in varied and numerous embodiments without departing from the scope of the invention. Indeed, those of ordinary skill in the art will readily appreciate that various of the components, features and structures illustrated in the figures may, in turn, be selectively combined to produce additional exemplary production line configurations and/or products that have not been illustrated in the interest of brevity, but which are wholly consistent with the mechanics and principles illustrated and described herein and therefore within the scope and spirit of the invention.

### DETAILED DESCRIPTION OF EXAMPLE EMBODIMENTS

It is anticipated that composite articles manufactured according to the invention will be suitable for applications including, for example, residential and commercial building applications, residential and commercial decking; residential and commercial fence and railing systems; docks and slipways; residential and commercial exterior finishing or cladding products; residential interior structural finishing and cladding products, alternatives to dimensional lumber in some applications; and infrastructure products such as highway sound control barriers.

Specific features and advantages associated with composite articles manufactured according to the invention may include one or more of reduced coefficient of thermal expansion, increased dimensional stability even at elevated temperatures, increased impact strength, improved structural durability, improved fire resistance, improved color fade resistance, improved resistance to mold mildew and algae growth, and associated improvement in fatigue resistance and other deleterious aging and/or wear phenomena, increased small area structural integrity (which allows for more complex cross sectional geometry—particularly with respect to fine detail such as alignment and structural tabs and/or interlocking elements), and improved fastener retention. Another anticipated benefit would be reduced splintering, flaking and localized failures of smaller features.

Other benefits and advantages may include increased material strength and stiffness that would allow more effective cross sectional design and the usage of thinner sections (and correspondingly less material and weight) to provide parts of equivalent strength. With the decrease in the weight of the parts with similar operating strengths, the lighter weight articles would reduce shipping costs and simplify handling for additional unit cost savings.

The use and incorporation of glass fibers will tend to improve resistance to moisture uptake, which in turn could enhance resistance to mold and mildew. The increased strength, particularly with regard to materials suitable for residential and commercial decking could allow for increased spans which in turn would reduced the level of supporting structure required to build a structurally equivalent assembly.

With regard to the glass composition itself, this invention will typically incorporate glass coupling agents and possibly other additives and processes for improving the incorporation and adhesion of the glass fiber within the composite article. The glass fiber may comprise up to about 40 wt. %, but more typically 15-30 wt. %, of one or more elements of the final composite article and may be combined with other elements that are substantially free of glass fibers. This invention also provides methods for glass fiber handling and delivery that allow for improved introduction of discrete glass fibers into a broad range of composite materials during the manufacturing process.

As noted above, composite articles fabricated in accord with the invention, particularly those that incorporate wet fibers (for example, WUCS) or other components that initially include or subsequently release water may incorporate one or more water scavengers. For example, in the course of preparing a polymeric component with WUCS for subsequent inclusion in a composite article can utilize gypsum particles as a filler that will tend to scavenge the water present in the wet glass fibers. Utilizing this scavenging function of the gypsum filler in one or more of the components used to form the composite article tends to reduce or eliminate the need for subsequent venting or drying that was previously necessary to remove water from the component(s) as steam during the subsequent elevated temperature molding and/or forming operation(s). In this respect, the gypsum filler functions as both a processing aid and as a filler that will tend to increase the bulk of the composite articles and improve their fire resistance.

The invention also encompasses the use of one or more polymer coupling agents to enhance the surface bond between not just the glass and resin, but also in the event that wood fibers or particles are used in combination with glass fibers, the surface bond between adjacent wood fibers or particles. It is anticipated that both recycled, including post-consumer, and virgin thermoplastic resins may be used successfully in manufacturing embodiments of the composite articles according to the invention. Further, although the composite articles and the associated methods of manufacture according to the invention are expected to utilize predominately extrusion processes, it is anticipated that some compositions within the scope of the invention would have properties suitable for use in injection molding processes as well and may be suitable for use in combination with premanufactured films, layers or inserts.

In most instances, it is expected that modified polyolefin polymers will be suitable for use as coupling agents applied to the glass substrate before the fibers are blended with the other components of the composite material. These polymers include, for example, maleic grafted polypropylene, polyethylene and polypropylene-polyethylene copolymers, ethoxylated polypropylene, polyethylene and polypropylene-polyethylene copolymer, and ethylene acrylic functional polypropylene, polyethylene and polypropylene-polyethylene copolymers. These additives, when applied to the glass in aqueous form act as adhesion promoters to improve the mechanical properties of wood plastic composites.

Embodiments of the invention may include the use of glass fibers and maleic anhydride grafted polyethylene and polypropylene polymers in tandem to improve the mechanical properties of wood plastic composites. Exemplary reinforced compositions will include between about 25 to about 45 wt. % polymer, between about 25 to about 45 wt. % wood fiber and/or wood flour, and about 5 to about 40 wt. % fiberglass, preferably WUCS. The coupling agent(s), for example maleic grafted polymer(s), may be used with the fiberglass in weight ratios between about 1:5 and 1:40 relative to each other. Using these components in these formula ratios will tend to improve the effectiveness of the fiberglass reinforcements.

The incorporation of wood fibers, wood flour and/or other organic fibers and fillers will be improved through the use of an appropriate compatibilizer. Exemplary compatibilizers include copolymers that provide a coupling function among various components of the composite material and/or can change the chemical environment of the compositions used to form the composite article that allows the various components to be more easily and/or uniformly dispersed to form a more stable composite. The specific manner in which the compatibilizer functions is not critical, but typically improved coupling functionality relative to conventional coupling agents is preferred.

A compatibilizer (or compatibilizing copolymer) typically represents a copolymerization reaction product of an olefin and at least one other comonomer. It is expected that a range of olefins can be used singly or in combination in practicing the invention including, for example, ethylene, propylene, isomers of butylene, and/or other common olefins of the type widely used in conventional polymerization reactions employing traditional (Zieglar-Natta) catalysts and/or more specific metallocene catalysts.

Useful compatibilizers are those that include a functional comonomer, e.g., a monomer that can be copolymerized with a suitable olefin under conditions suitable for olefin-polymerization, that also includes an anhydride functionality. An exemplary functional comonomer is maleic anhydride and its general functional equivalents such as maleic anhydride derivatives such as maleic acid and/or its salts; maleic acid diesters or monoesters, including esters of C₁-C₄ alcohols, such as, for example, methyl, ethyl, n-propyl, isopropyl, and n-butyl alcohols; itaconic acid; fumaric acid; fumaric acid monoester; and mixtures thereof. Of particular note with regard to the selection of appropriate compatibilizers are maleic anhydride and its monoesters and/or diesters.

Useful compatibilizers also include terpolymers of ethylene (E); maleic anhydride and/or it chemical equivalents; and a third comonomer, X, selected from a group including, for example, vinyl acetate, (meth)acrylic acid, and/or derivatives thereof. Suitable derivatives of (meth)acrylic acid include salts, esters, anhydrides, or other acid derivatives are known to one of ordinary skill in the chemical arts including preferred acid derivatives including, for example, methyl acrylate and/or butyl acrylate.

These compatibilizers can be present in those components of the composite article that incorporate wood and/or other organic materials an amount of about 0.1 to about 10 weight % based on the total weight of the composition. Preferably the compatibilizer is present in an amount of from about 0.25 wt % to about 5 wt %, more preferably in an amount of from about 1 wt % to about 4 wt %. As will be appreciated by those skilled in the art, the concentration of compatibilizer necessary to obtain a desired result will be a function of the polymers used, the type of organic material being incorporated and the particular compatibilizer(s) being utilized.

One or more compatibilizers, particularly those including higher concentrations of the functional comonomer(s), can be blended with other polymeric materials to dilute the concentration of the functionality and thereby provide a blended composition for use in various types of wood composite materials.

As suggested above, wide variety of cellulosic and other fibrous and/or filler materials can be employed in the present invention. Illustrative cellulosic materials can be obtained from, but are not limited to, wood and wood products, such as wood pulp fibers; non-woody paper-making fibers from cotton; recycled paper materials; straws and grasses, such as rice and esparto; canes and reeds, such as bagasse; bamboos; stalks with bast fibers including, for example, jute, flax, kenaf, cannabis, linen and ramie; and leaf fibers, such as abaca and sisal. The cellulosic materials can be used singly or in combination.

Wood and wood products may be especially suitable for inclusion in one or more of the polymeric components of the composite articles according to the invention. Suitable wood sources will typically include softwood sources such as pines, spruces, and firs, and hardwood sources such as oaks, maples, eucalyptuses, poplars, beeches, and aspens. The form of the cellulosic materials from wood sources, particularly waste wood sources, can be incorporated into the polymeric components as one or more of sawdust, wood chips, wood flour and/or wood fibers.

As will be appreciated, in addition to wood products, cellulosic materials obtained from other agricultural residues and/or industrial waste can be incorporated into one or more of the polymeric components used in forming a composite article according to the invention. Examples agricultural residues will include, for example, the residue remaining after harvesting wheat, rice, corn and/or other grain stocks such as straw; corn stalks; rice hulls; wheat; oat; barley and oat chaff; coconut shells; peanut shells; walnut shells; jute; hemp; bagasse; bamboo; flax; and kenaff; and combinations thereof. Additional discussion of these materials and other components that may be incorporated in the composite articles according to the invention may be found in WO 05/080496, published Sep. 1, 2005, the disclosure of which is incorporated herein, in its entirety, by reference.

One or more of the polymeric components that comprise a composite article according to the invention, particularly exposed components, may include one or more fire retardants such as magnesium hydroxide, zinc borate, gypsum (hydrated calcium sulfate). These additives may either be used in a specific region or component, for example, a capstock, as in the case of a multiple extrusion, or as an additive incorporated in a gelcoat, e.g., a typically quick-setting resin used in molding processes for providing an improved surface for the composite. In molding processes, the gelcoat may be the first resin applied to the mold after the mold-release agent, thereby becoming an integral part of the finished composite article.

Alternatively, one or more additives may be distributed throughout the entire product with the various polymeric components having similar or substantially different effective concentrations of the additives depending on the functional results of the additive and the need for that function in the particular polymeric component. For example, UV stabilizers will more likely be concentrated in one or more surface layers while processing aids for foaming agents may be found only in internal reduced density components.

One issue relating to the use of fiber reinforcement in compression, extrusion or injection molded materials is the distribution of the reinforcement within the final article, or within one or more components of a composite article, necessary to achieve acceptable mechanical, thermal and impact performance. With fiberglass reinforcement, the strength improvements tend to be proportional to the glass content with a typical reinforced part containing between about 15 to about 60% by volume in the final part.

Those skilled in the art appreciate that in order to achieve a generally uniform distribution of the fiberglass reinforcement, particularly at higher loadings, it is preferred that the fiberglass meet certain geometric and chemical criteria. These criteria include, for example, the configuration of the fiberglass with bundle forms being preferred for the resulting flow properties, the glass bundle tex must be selected and maintained within a range necessary to achieve a desired aesthetic appearance, e.g., little or no fiber prints apparent on the surface of the part. Bundle tex relates to the size of the fiber bundle and is provided in units of weight divided by length, typically in grams/kilometer. The fiberglass bundles should exhibit sufficient cohesiveness to retain the bundle configuration during the necessary processing, e.g., good “bundle integrity,” and any size or binder compositions incorporated with the fiberglass reinforcement should exhibit good compatibility with the primary matrix resin or blend of resins.

A variety of size compositions are known to those skilled in the art, many of which include one or more silanes, for example A-1100 aminosilane, A-174 methacryloxysilane, A-187 epoxy functional silane and A-171 vinylsilane. The film former component of the size composition should be one that will not result in undue “blocking,” e.g., the large scale sticking together or agglomeration of fibers subsequent to the drying step, while at the same time proving sufficient bundle integrity for subsequent process steps, and exhibiting sufficient compatibility with the resin matrix. Additional discussion of exemplary size compositions may be found in U.S. Pat. No. 6,025,073, the contents of which are hereby incorporated, in its entirety, by reference.

Various known combinations of urethanes and acrylics are expected to be suitable for practicing the invention and other combinations of unsaturated polyesters, epoxies, acrylics and modified vinyl acetates are expected to be suitable as well. Other additives may include lubricants, including both cationic lubricants, such as Emery 6760 L, and nonionic lubricants, such as PEG 400 monooleate and mono isostearate, strand stiffeners, for example N-vinylpyrolidone, catalysts and other conventional additives.

The fiberglass bundle tex can be controlled by splitting the primary strand as many times as necessary on the chopping cot. The bundle integrity may be controlled to some extent by applying the appropriate film former(s) to the fiber using conventional techniques and by applying enough energy, particularly in the form of radiofrequency (RF) energy, to convert the aqueous film former composition to dry film on the fiber surfaces that shows a reduced blocking tendency. A combination of a polyurethane dispersion, for example Witcobond W290H, Hydrosize U1-01 or Hydrosize U2-01, and a urethaneacrylic alloy such as Witcobond A-100 can be used to form a suitable size composition.

As will be appreciated by those skilled in the art, composite articles fabricated according to the invention may also include one or more reduced density components, particularly for filling one or more voids defined by other components, for example a structural component. These reduced density materials may be prepared using a variety of methods, depending in part on the properties desired for the final component. Such methods include, for example, producing foams through chemical reactions and/or the reducing the pressure under which the polymeric component is maintained to allow one or more blowing agents incorporated in the polymeric composition to expand and form a foam. Such methods may be used in conjunction with one or more light weight filler materials including, for example, exfoliated minerals and inorganics and/or microspheres.

### First Embodiment

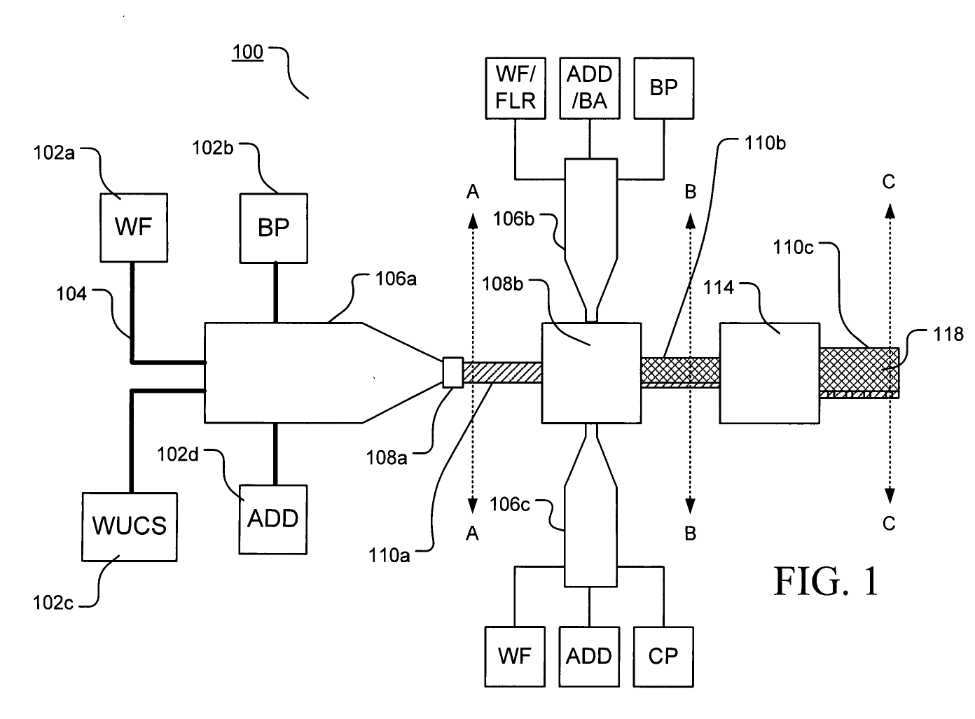

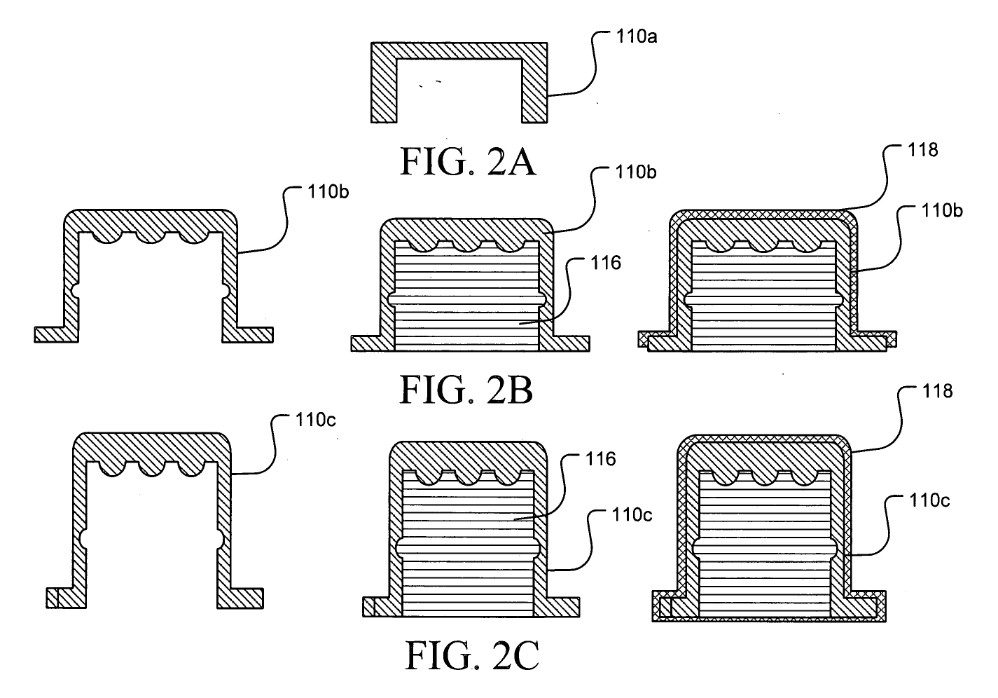

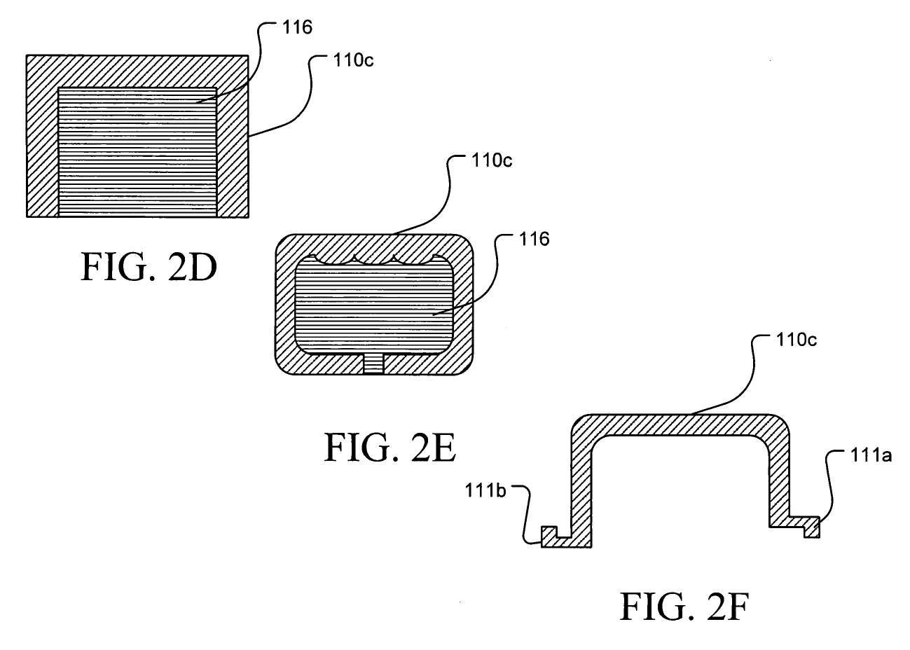

Illustrated in FIG. 1 is an example of a manufacturing line according to an embodiment of the invention in which various components such as wood fibers (WF) 102a, base polymers (BP) 102b, wet use chopped strand fiberglass (WUCS) 102c and other additives (ADD) 102d are provided through feed lines 104 to a blender/extruder mechanism 106a. Similar blender/extruder mechanisms 106b and 106c may be used to prepare one or more additional compositions for combination with the primary structure or initial form 110a as it is extruded from die 108 or shortly thereafter to fabricate a composite article. The other compositions may be prepared in the blender/extruder mechanisms 106b, 106c to form uniform mixtures having a suitable temperature and viscosity and then extruding the mixture through one or more dies included in apparatus 112 to form an initial form 110a. An example of a cross-section of initial form 110a along plane A-A is illustrated in FIG. 2A.

As suggested in FIG. 1, the components used in preparing the various compositions may be quite different and specifically selected to provide a desired combination of properties at a preferred price point. For example, the second or filling composition may include wood fibers (WF) or other fillers (FLR), additives (ADD) and, if being provided as a foam, a blowing agent (BA) in addition to the base polymer (BP) or polymer blend. Similarly, the third or surface composition may or may not include wood fibers or other reinforcing or filling agents, but will typically include additives intended to provide a desired combination of properties including, for example, color, colorfastness, durability, fire retardancy and skid resistance, in addition to a cap polymer (CP).

If desired, the initial form 110a may then be subjected to additional heating and/or forming operations in unit 112 to modify the initial form an produce an intermediate form 110b having a more complex cross-sectional profile. An example of a cross-section of an intermediate form 110b along plane B-B is illustrated in FIG. 2B. As illustrated in FIG. 1, if desired, the intermediate form 110b can also be then be subjected to additional heating and/or forming operations in unit 114 to modify the intermediate form to produce a final form 110c having an even more complex cross-sectional profile incorporating, for example, notches, fastener holes, tabs or other structures that will increase the utility of the final product. An example of a cross-section of final form 110c along plane C-C is illustrated in FIG. 2C.

Although as illustrated in FIGS. 2A-2C, the extrusion may be limited to a single uniform material, the basic forms may be also be and typically will be further modified with a filler material, for example a foam or other less structural filler composition 116 as illustrated in FIG. 2D and/or modified to provide a more “closed” configuration as illustrated in FIG. 2E. As illustrated in FIG. 2F, the structural component may also be modified to form complementary flanges 111a, 111b or other complementary projecting and/or recessed structures that may provide alignment and/or interlocking functions for the final product.

### Second Embodiment

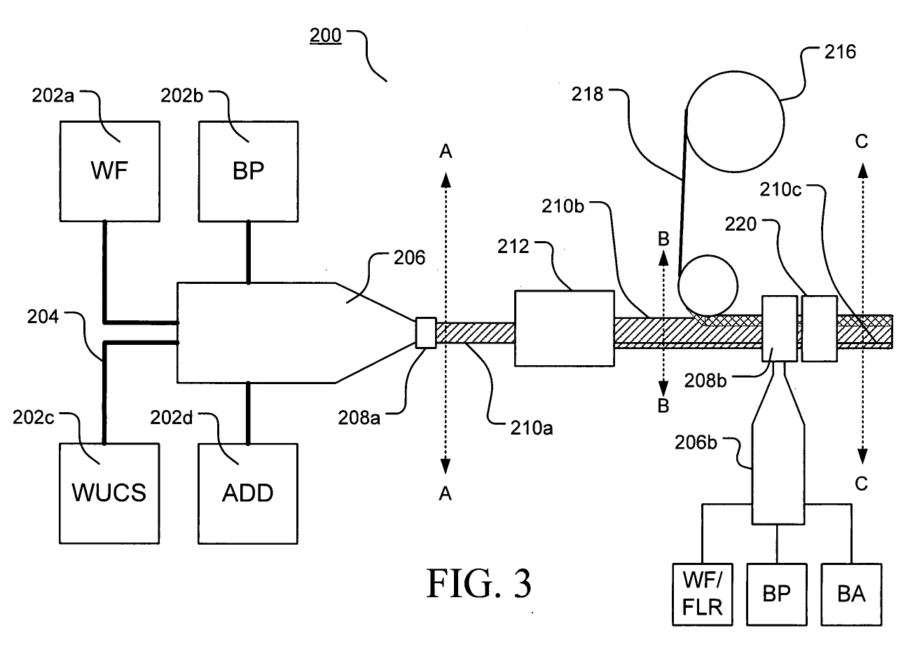

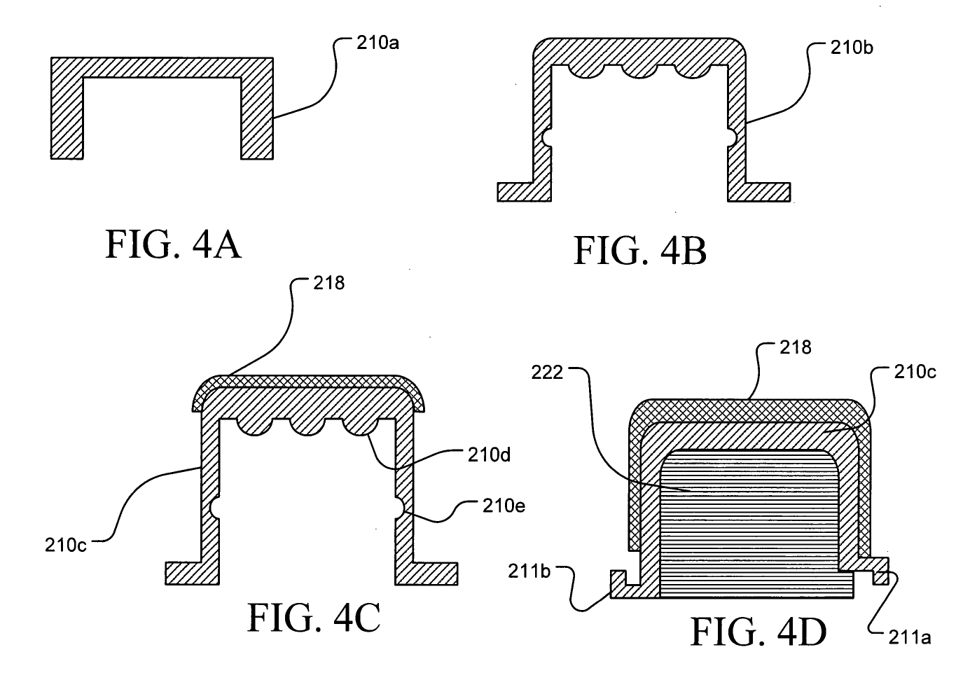

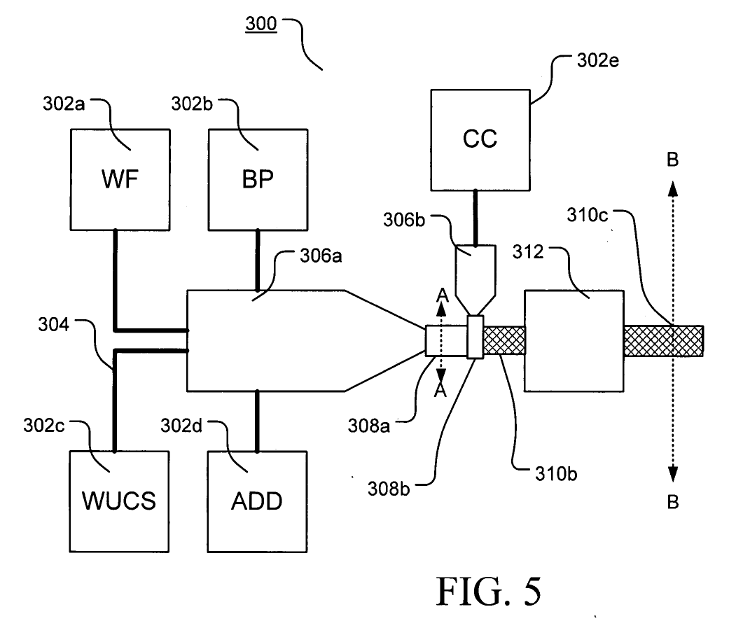

Illustrated in FIG. 3 is an example of a manufacturing line according to another embodiment of the invention in which various components such as wood fibers (WF) 202a, binders and/or polymers (BP) 202b, fiberglass reinforcement (WUCS) 202c and other additives (ADD) 202d are provided through feed lines 204 to a blender/extruder mechanism 206. The various components are combined in the blender/extruder mechanism 206 to form a uniform mixture having a suitable temperature and viscosity and then extruding the mixture through a die 208 to form an initial form 210a. An example of a cross-section of initial form 210a along plane A-A is illustrated in FIG. 4A.

If desired, the initial form 210a may then be subjected to additional heating and/or forming operations in unit 212 to modify the initial form an produce an intermediate form 210b having a more complex cross-sectional profile. An example of an intermediate form 210b is illustrated in FIG. 4B. As illustrated in FIG. 3, a finish layer, capping layer or other desired film or layer 218 may be applied to at least a portion of the surface of the intermediate form 210b from a supply 216. The additional layer or film 218 can be applied as a premanufactured film or may be applied as a secondary extrusion (not shown).

Depending on the intended use and the composition of the primary material used to form the intermediate form 210b and the additional layer or film 218, the composite structure of the intermediate form and the additional layer or film can be then be subjected to additional heating and/or forming operations in unit 214 to modify the intermediate form as detailed above and/or increase the attachment between the primary material and the secondary material of the additional layer to produce a composite final form 210c. A cross-sectional example of a final form 210c is shown in FIG. 4C illustrating the application of the layer 218 has been added. Both FIGS. 4B and 4C reflect additional reinforcing ribs 210d and recesses 210e that can be formed in the basis extrusion for modifying the relative thickness and/or strength of regions of the basic form. As illustrated in FIG. 4D, the additional processing to which the intermediate form 210b is subjected may include at least partially filling the intermediate form, typically with a foam material or less expensive fill composition 222 to produce a more solid structure.

### Third Embodiment

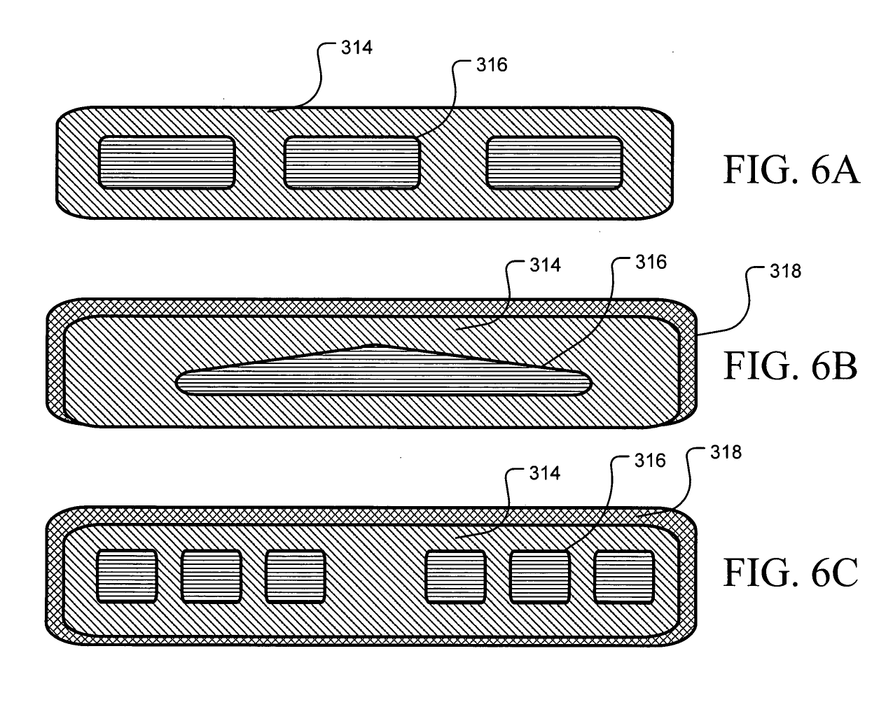

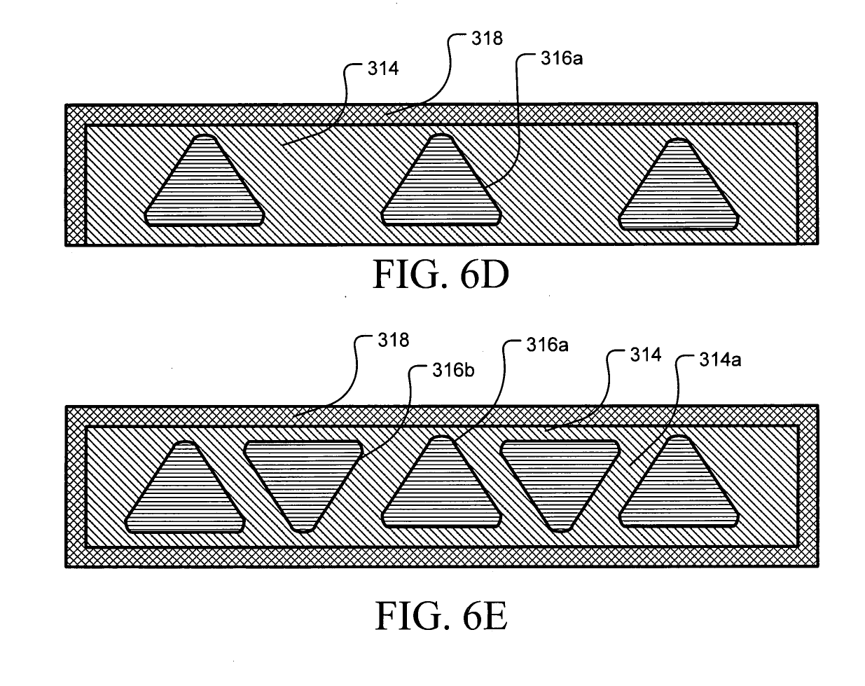

Illustrated in FIG. 5 is an example of a manufacturing line according to another embodiment of the invention in which various components such as wood fibers (WF) 302a, binders and/or polymers (BP) 302b, fiberglass (WUCS) 302c and other additives (ADD) 302d are provided through feed lines 304 to a blender/extruder mechanism 306a. The various components are combined in the blender/extruder mechanism 306a in different proportions to form at least two separate and distinct compositions at suitable temperatures and viscosities for extrusion processing. The two compositions are then extruded through a die 308a to form an initial form 310a in which a first composition 314 forms a primary structural frame for the final product with a second composition 316 at least partially filling recesses defined in the primary structural frame form. An example of a cross-section of initial form 310a along plane A-A is illustrated in FIG. 6A in which the first composition 314 is extruded as a closed channel structure with the second composition 316 filling the recesses defined between the channel walls.

As illustrated in FIG. 5, this initial form 310a may be fed into another extrusion die 308b in which a capping layer, finish layer or decorative layer 318 of a capping composition CC is applied to the initial form 310a from a to form the basic composite product 310b. An example of a cross-section of initial form 310b along plane B-B is illustrated in FIG. 6B. As suggested above in connection with the previous embodiments, the basic composite product 310b can also be subjected to additional processing in one or more stations 312 where, for example, the product may be subjected to additional machining or forming to obtain a final cross-sectional profile or surface finish, introduce additional structures for improved utility. In addition to mechanical operations, the product may be subjected to, for example, one or more processes involving the application of colorants, sealants, friction modifiers, wear retarding layers, heat or UV curing to obtain the desired combination of functional and decorative features for the intended application.

Illustrated in FIGS. 6A-6E are various composite articles according to the invention including two or more components formed from a first structural composition 314, a second, typically less structural composition 316 and a third surface or finish composition 318, each of which will be formulated or compounded to provide a distinct set of mechanical and durability properties. As suggested in FIGS. 6A-6E, the distribution and configuration of the various components can be varied widely to produce composite articles having a desired combination of size, strength, appearance and functionality.

As illustrated in FIGS. 6B and 6D, if present, the capping layer 318 does not necessarily encompass the entire perimeter of the structural 314 and secondary 316, 316a, 316b components or structures. Particularly when the product will be installed with a primary surface concealed, omitting the capping layer from the concealed surfaces can reduce the overall cost of the product. As also suggested by FIGS. 6A-6E, the recesses defined within the primary structural frame of the first material 314 and filled with a secondary material 316, 316a, 316b and/or other materials (not shown) need not have any particular shape, uniform size, uniform orientation or uniform spacing. It is anticipated that the configuration of the recesses will be a function of the mechanical properties of the first material 314 and the configuration and intended use of the final product. These two parameters will determine, in large part, the dimension and configuration of the primary surface layers and the internal supporting or bracing structures 314a necessary to achieve the intended functionality.

To the extent that the desired result can be achieved with something other than a solid mass of the first material, the recesses or voids can be left empty (not shown) or filled with a coextruded material 316 which may or may not expand or foam to some degree after extrusion. Particularly for flooring or decking applications, it is anticipated that filled embodiments may reduce sound transmission and/or heat transmission while possibly improving fastener retention and/or improving rigidity.

As illustrated in FIG. 6E, higher strength materials and/or a less demanding application compared to that for the product illustrated in FIG. 6D, will allow the relative volume of the filled 316a, 316b regions to be increased relative to the main surfaces 314 and the interconnecting struts, bars or webs 314a that are intended to provide the primary structural function. By utilizing distinct compositions to achieve the various functions, utility and appearance of the final products, the exemplary composite structures illustrated in FIGS. 6A-6E can achieve improved performance and/or reduced cost relative to more homogeneous constructions.

For example, by utilizing a capping or surface layer 318 that does not need to perform a predominate structural function, the invention provides for more efficient use of expensive additives, for example UV stabilizers, that provide no appreciable benefit when incorporated into material(s) that form the bulk of the product. As will be appreciated by those of ordinary skill in the art, the same will hold true for other additives incorporated to improve other specific properties or parameters including, for example, abrasion resistance, fire retardancy, mold resistance, surface feel and/or roughness, wear properties as well as color retention. Similarly, by avoiding the need to blend the primary material to achieve suitable appearance and surface properties, the primary material may be modified to enhance its structural performance including, for example, one or more of strength, flexibility, hardness and thermal expansion.

It is anticipated that one application for which products manufactured in accord with the invention will be especially suited will be composite deck boards. As will be appreciated, there remains a need for composite deck boards that exhibit improved performance in one or more areas including, for example, one or more of span ratings, appearance, weatherability, thermal performance and durability. As detailed above, although a range of configurations according to the invention may achieve one or more of these improvements, it is anticipated that multi-component deck flooring products corresponding to embodiments of the invention manufactured using, for example an exemplary tri-extrusion process as detailed above will incorporate one or more of the desired improvements.

Conventional composite deck boards are typically manufactured by extruding a thermoplastic resin, such as one or more of polyethylene, polypropylene and PVC, that has been blended with wood flour and/or fibers, lubricants, and additives in an effort to lower production costs and/or improve the composite board properties. In most instances, therefore, such conventional processes produce composite boards manufactured completely from a single composition in which any additives and fillers present in the composition are dispersed substantially uniformly throughout the entire thickness and width of the resulting composite board. Accordingly, in order to obtain sufficient concentrations of UV stabilizers or other bulk additives in those portions-of the composite board where they are actually required, the manufacturer must add quantities of a suitable (an relatively expensive) UV stabilizer or stabilizers that are essentially, if not totally, wasted in the interior regions of the composite board.

Although other manufacturing processes may be utilized, as detailed above it is anticipated that a three-component structure manufactured utilizing at least one coextrusion process will be particularly suitable. Depending on the various components and proportions used to manufacture the respective materials, processes and dyes used, it is expected that exemplary products manufactured and/or configured in accord with the invention, the products may include deck planking, balusters and/or capping or “capstock” materials.

As will also be appreciated, depending on the intended application of the product, recesses and voids formed in the primary structural frame may be filled with a foaming or other light weight composition to produce a composite article having a substantially “solid” cross section. If foam is utilized as the filling material, it will typically be produced through the use of one or more blowing agents, for example CO₂ or N₂ that is both non-toxic and non-combustible. By using such blowing agents, or a compatible blowing agent system, the continued presence of the blowing agent in the foam will not present additional concerns or reduce the performance of the composite product.

The foamable or filled core composition will preferably include one or more colorants, dyes or pigments so that if a cross section of the composite article is exposed by, for example, sawing a composite decking plank, the various components will cooperate to provide a fairly uniform and “solid” appearance. This uniform appearance will typically require at least the structural component(s) and the filling or core components having similar final colors in order to avoid highlighting the presence of different materials. The capping or cover layer, however, is relatively thin and will not tend to contribute as significantly to the cross-sectional appearance.

With regard to texture, if a foamable mixture is used in the core component, it may be compounded with nucleation materials and/or expanded under conditions that will produce foams having a relatively small cell size to avoid highlighting the presence of different materials through distinct surface textures. Further, if a foamed material is utilized and will not be completed enclosed, it is preferable that the foamable composition be selected so that a skin layer will form at the exposed surface and thereby avoid the appearance of open cells and more closely match the texture and appearance of the surrounding structures. Similarly, if the core component is formed from a lightweight filled composition, the size and coloration of the fill materials should be selected so that the core component does not exhibit an “aggregate” appearance with distinct discontinuous and continuous phases when viewed in cross-section.

Because the fill or core material need not provide a significant portion of the structural strength of the composite articles according to embodiments of the invention, the core material may be formulated using less expensive (and accordingly weaker) polymeric compositions such as foams and more highly filled materials. Similarly, because in some embodiments the fill or core material will be exposed only when the composite article is cut, the core material may be formulated with lower loadings (if any) of reinforcing materials and will typically include lower concentrations (if any) of those additives intended primarily for improving appearance, for example, color fastness, scuff resistance and finish texture.

In certain embodiments of composite articles according to the invention, an increased contribution to the overall strength of the composite article can be achieved by incorporating reinforcing fibers, for example WUCS, into the foamable or filled composition. Including reinforcing fibers in the core or fill component can also improve the apparent uniformity between the reinforced structural components and the core component when viewed in cross-section.

The capping, finishing or final layer 318 applied to the primary structure will typically incorporate higher concentrations of certain additives, for example UV stabilizers, wear resistors, anti-skid materials and/or other antioxidants relative to the other compositions incorporated in the final product. Similarly, as suggested above material 314 used to form the primary structural frame can be reinforced with higher levels of glass fibers that those incorporated into the other compositions to modify one or more mechanical performance parameters to obtain a product that better satisfies the requirements of a particular application.

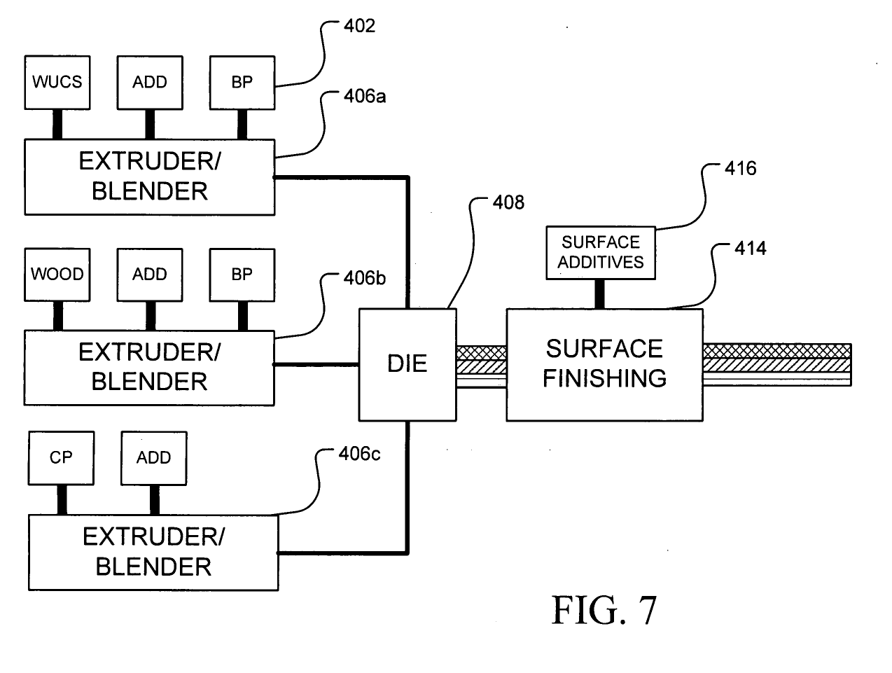

Illustrated in FIG. 7 is an example of a manufacturing line according to another embodiment of the invention in which various components such as wood fibers (WOOD) binders and/or polymers (BP), capping polymer (CP), fiberglass (WUCS) and various additives (ADD) maintained in separate reservoirs 402 are provided through feed lines to a series of blender/extruder mechanisms 406a, 406b, 406c. The various compositions prepared in each of the blender/extruder mechanisms may then be coextruded through a die component 408 to form a basic composite article. One or more of the exposed surfaces of the basic composite article may then be subjected to additional modification in subsequent equipment 414 through the addition of surface additives 416 and/or mechanical modification of the surface topography.

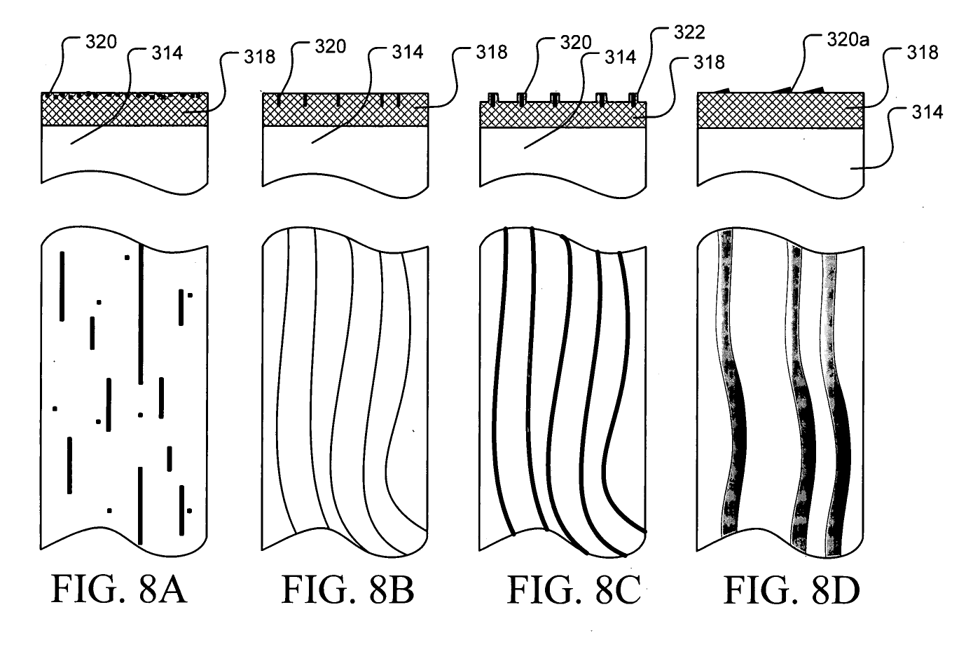

As illustrated in FIGS. 8A-8D, the combination of additional materials and/or surface processing may be used to create composite articles having a range of appearance and surface textures that can, for example, more accurately simulate natural wood plank surfaces, increase skid resistance and/or provide other desirable features. As illustrated in FIG. 8A, surface additives 320 can be introduced onto and/or into the surface or capping layer 318 supported on a structural component 314 to provide contrasting areas including both defined spots and elongated regions. As illustrated in FIG. 8B, the surface additives can be introduced as deeper continuous bands that extend into (or even through) the surface layer 318. As illustrated in FIG. 8C, the surface of the surface layer 318 can be milled or pressed to create ridges of material that may or may not (not shown) correspond to contrasting surface additives 320. As illustrated in FIG. 8D, the surface additives may be configured as a wedge-shaped strip 320a of a translucent material whereby the imposed “grain” will be perceived as providing a gradation of color across the band of material. The wedge-shaped strip may be applied so that the exposed surface is flush with the primary surface of the surface layer 318 (not shown) or so that the thicker part of the strip protrudes from the primary surface to provide surface texture. As will be appreciated, the illustrations provided in FIGS. 8A-8D are not to scale and are not exhaustive, but are intended instead to suggest the range of surface configurations and appearances that can be achieved on composite articles according to the invention by those skilled in the art.

As discussed above, the capping, finishing or final layer 318 may be milled, embossed or otherwise machined or processed to produce a textured surface to provide a more natural, distinctive or safer surface as desired. In addition to the mechanical processing, the capping layer 318 may be fabricated from a composition to which one or more additives including wood, clay, other fillers, different polymers, reinforcing fibers and/or colorants have been added. The combination of the additives and the surface processing may be utilized to produce composite articles having, for example, a more natural wood appearance, e.g., by simulating the coloring, grain and/or texture of a natural board, or to provide an appearance that mimics other natural or conventional construction materials, for example, stone or aggregate. It is anticipated that capping layers that result in composite articles more effectively and realistically simulating natural or widely accepted construction materials would increase their level of acceptance and use in the building and decorating trades.

Alternatively, the combination of the additives and surface processing may be utilized to produce composite articles having a distinctive and decorative that does not obviously suggest any natural surface. For example, the combination of the additives and surface processing may be selected to duplicate the appearance of conventional wood plastic composites so that it will tend to blend with and/or complement existing installations and thereby be more suitable for repair or replacement applications.

As noted above, in addition to the particular combination of components used to form the surface coating, the coating can also be subjected to one or more forms of mechanical processing during and/or after formation. For example, the surface coating or capping layer may be subjected to embossing, pressing, stamping, planing, milling or other processing in order to add texture to the capping layer that simulates a natural “wood grain” feel.

Embossing, for example, may be configured as a continuous process in which the composite article exiting an extruder die is fed through a set of pinch rollers, at least one of which includes a raised pattern that will be imprinted on to the surface to which the roller is applied. Pressing, for example, may comprise a batch process in which a series of composite articles, for example decking boards, are sequentially loaded and pressed in a textured mold under temperature and pressure conditions suitable for transferring the mold texture to one or more surfaces of the boards. Planing may be configured as a batch or a continuous process in which at least portions of the capping layer are removed by rotating or oscillating blades. Although in conventional woodworking, planing is a process typically utilized for smoothing and/or leveling a board surface, in this instance it may be adapted for selectively removing portions of the capping layer to cut a desired texture or pattern into the processed surface. The texturing process(es) utilized for producing a desired surface appearance and texture in the final composite product will, to some degree, guide the selection of appropriate capping layer compositions and the thickness of the capping layer, particularly if the process involves removing a portion of the capping layer.

Conventional foamed boards tend to exhibit inferior mechanical properties than solid boards of similar dimensions. Some attempts have been made to improve the mechanical properties of foamed boards by incorporating glass fibers, but such attempts have not produced compositions in which the glass fibers are both present in sufficient quantities and exhibit sufficient adhesion to the polymeric resin(s) to achieve the desired improvement in the mechanical properties. As noted above, composite articles according to an embodiment of the invention utilize WUCS treated with an appropriate size composition in the foamed core to improve mechanical properties. Because WUCS production does not require the drying and/or curing steps utilized in the production of conventional fiber reinforcements, WUCS may provide both economic and performance advantages over conventional fibers in the production of both foamed articles and composite articles incorporating foamed components.

Further, with regard to the composite articles fabricated according to the various embodiments of the invention, it is anticipated that the coextrusion process will tend to reduce undesirable interactions between components that may be separated in two or more compositions that will, in turn, be utilized to form a final composite structure. For example, one problem often associated with the use of additives in wood/plastic composite materials is the absorption of the additives by the wood flour, thereby lowering the effectiveness of a particular concentration of the additive(s). Thus, by separating at least certain of the additives into components that do not include wood flour, or have a reduced wood flour component, it is expected that improvements will be noted in the effectiveness of a given additive package in such a component. This, in turn, will allow the quantity of the additives to be reduced and/or increase the effectiveness of a defined additive package intended, for example, to increase resistance to UV degradation.

It is also anticipated that the multi-extrusion process detailed above will provide certain advantages in attempting to improve both material usage and turn costs. For example, the composition used for forming the primary structural frame could incorporate higher concentrations of reinforcing fibers, for example, WUCS, for improving mechanical properties while allowing the capping and core layers to remain relatively free of reinforcing fibers. These improvements in material strength can be leveraged to reduce the quantity of material necessary to obtain a target strength and/or rigidity, typically by utilizing a more complex cross-section, as illustrated in, for example, FIG. 6D, whereby the structural component(s) occupy only a small percentage of the total cross-sectional area. Accordingly, limiting the volume of material into which the reinforcing fiber must be incorporated can significantly reduce the contribution of the reinforcement to the overall cost of the final product.

Again, as noted above, the primary structural frame will typically define a plurality of recesses, channels or cavities that may, in turn, be filled using one or more less expensive materials that will tend to exhibit correspondingly less robust mechanical properties. Although, as noted above, the spaces defined by the primary structural frame may be left unfilled, it is anticipated that most private individuals and contractors reviewing their options in terms of composite decking materials will have at least some preference for those articles, whether solid or composite, that exhibit a sufficiently “solid” appearance. Accordingly, the use of one or more filling materials including, for example, foamed polymer(s), polymer/wood compositions with higher wood flour concentrations and/or combinations of two or more compositions to fill any significant voids in the structural component will be preferred.

Although, as detailed above composite boards according to the invention are anticipated to be particularly useful in exterior decking applications and may be provided in a range of configurations such as planks, balusters and capping trim in a variety of lengths, widths and thicknesses. The improved durability, dimensional uniformity and appearance may also allow for other applications including, for example, window and door framing. Indeed, depending on the particular materials, configuration and application, composite articles according to the invention may be approved for structural applications, such as some framing, particularly in non-load bearing applications.

Although exemplary, non-limiting embodiments of the invention have been described in detail hereinabove, it should be understood that many variations and/or modifications of the basic inventive concepts herein taught, which may appear to those skilled in the art, may still fall within the spirit and scope of the example embodiments of the invention as defined in the appended claims.

### Fourth Embodiment

A fourth embodiment according to the invention may be prepared without incorporating any wood particles in any of the polymeric components that make up the composite article. For example, in a composite article incorporating a capstock, the polymeric material from which the capstock is fabricated will typically be a filled and additive-modified polymer that includes one or more additives that would be expected to provide improved wear and color fastness characteristics. The second or intermediate section would typically be a glass fiber-reinforced polymeric material having sufficient strength and stiffness and a configuration that will allow this section or component to serve as the structural skeleton, i.e., of the composite article. The third element, which may also be referred to as a core or filler element, will typically include one or more reduced density materials, particularly one or more foamed polymeric materials or light weight fill material. By avoiding the use of wood fibers or flour, the resulting composite according to the fourth embodiment will tend to exhibit improvements in those parameters affected by the nature and characteristics of the wood products and/or byproducts relative to corresponding composite articles that do incorporate wood or other organic fiber material.

By avoiding the use of wood or other organic materials, the resulting composite article will tend to exhibit improved resistance to certain problems associated with organic materials including, for example, mold, mildew, bacteria or insects, without the need for similar quantities of biocides or other preventative treatments. It is also anticipated that the elimination or reduction of wood products, particularly in the capstock or surface layer would have benefits in respect any related manufacturing processes. In particular, the capacity of equipment necessary for storing, conditioning, processing, transporting and/or incorporating wood or other organic materials into the polymeric compositions may be significantly reduced. Reductions in the number and/or capacity of such equipment will tend to reduce costs and avoid potential hazards associated with the dust generated by and/or solvents used for processing the wood or other organic materials.

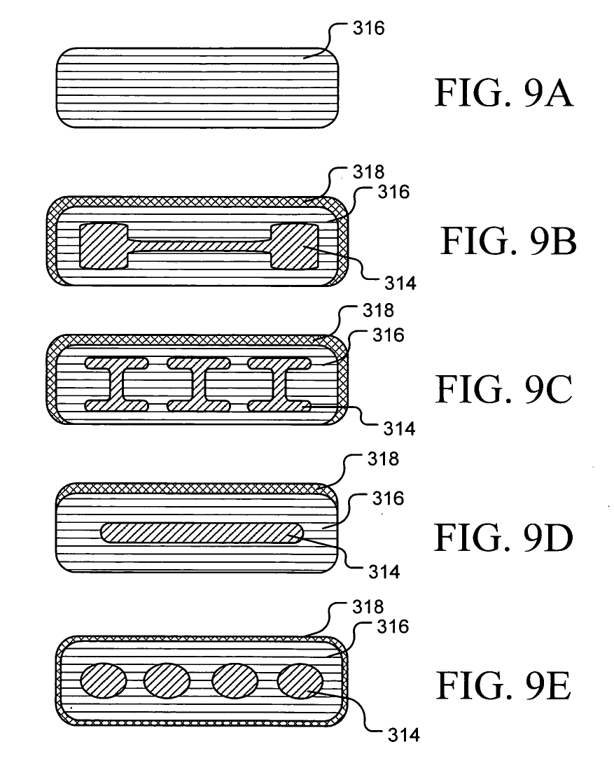

Further, although it is anticipated that in most instances the structural component formed from the first polymeric composition and/or the surface or finish layer will form the exterior of the composite article, in some instances the second polymeric composition may form the bulk of the article. As illustrated in FIG. 9A, the basic construction according to this embodiment is an extruded slab of a polymeric foam composition 316. Using the coextrusion processes and apparatus detailed above, additional components may be incorporated with and/or applied to the basic polymeric foam composition to improve selected properties including, for example, appearance and strength.

As illustrated in FIGS. 9B-E, a full or partial finish layer 318 and a one or more reinforcing elements 314 can be incorporated into the primary foam composition. As will be appreciated by those skilled in the art the relative quantity and configuration of the reinforcing component 314 can be used to increase horizontal and/or vertical strength and may be incorporated as relatively simple, FIGS. 9D and 9E, or complex, FIGS. 9B and 9C, shapes.

### Fifth Embodiment

A fifth embodiment of a composite article according to the invention provides improved fire retarding performance. Although the basic product configuration may be similar to that described above in connection with the fourth embodiment (no wood flour, fiber, or particles present), the fifth embodiment will utilize a capstock composition that includes higher filling levels and/or concentrations of one or more fire and flame retardant and/or smoke suppressing materials including, for example, various organic halogen compounds, phosphorus compounds, antimony trioxide, alumina trihydrate, magnesium hydroxide, zinc borate, metal chelates incorporating Fe, Co, Ni, Cu, or Zn (particularly in combination with Al(OH)₃ and Mg(OH)₂), and various intumescent compounds.

By incorporating higher levels of these fire and flame retardants and/or suppressants, for example, magnesium hydroxide (MgOH₂), in the capstock layer, in combination with the internal structural component(s), particularly those that are reinforced with higher levels of glass fibers, a composite article may be fabricated that exhibits improved resistance to burn through and/or sagging in the event of a fire. In such a composite article, the capstock layer acts as an ablative or energy absorbing layer while the reinforced structural component or substrate supports the capstock and provides an improved physical barrier. Composite articles fabricated according to this embodiment are expected to have particular utility in fire-rated building products.

### Sixth Embodiment

A sixth embodiment of a composite article according to the invention can provide an improved and/or more natural surface appearance. In this embodiment, during fabrication of the composite article a combination of polymers, which may be provided in one or more forms including fiber, flake, particle and pellet, are introduced into the capstock layer or the surface layer. Depending on the composition, form, the apparatus used to achieve the incorporation or addition and the various additives such as fillers and colorants incorporated in the polymer(s) being added, a range of surface effects can be produced. For example, adding polymer(s) having a darker color than the base polymer composition can produce variegated surface finishes that can more realistically mimic the grain of natural wood products.

Similarly, incorporating polymers having various colors and/or fillers can be used to create a wide range of distinct and highly customizable finishes that may or may not mimic natural materials. This ability to provide different finishes and looks through this technique may increase the use of these materials by designers and stylists in the manner in which other existing synthetic materials such as CORIAN® and/or synthetic stone products such as SILESTONE® are specified and employed. Accordingly, composite articles according to this embodiment of the invention may be acceptable for uses and applications ranging from exterior decking to interior and exterior finishing systems.

### Seventh Embodiment

A seventh embodiment of a composite article according to the invention can utilize a more substantial foamed component while still providing an improved and/or more natural surface appearance. In this embodiment, the majority of the composite article comprises a polymeric foam that may incorporate minor internal structural components and/or a capping or finish layer intended to provide improved appearance and/or durability. In lieu of the capping or finish layer, as the polymeric foam is extruded a combination of polymers, which may be provided in one or more forms including fiber, flake, particle and pellet, may be introduced into an outer portion of the foam. Depending on the composition, form, the apparatus used to achieve the incorporation or addition and the various additives such as fillers and colorants incorporated in the polymer(s) being added, a range of surface effects can be produced. For example, adding streaks or stripes of polymer composition(s) having a darker color than the base polymer composition can produce variegated surface finishes that can more realistically mimic the grain of natural wood products.

Further, as noted above, in addition to the particular combination of materials introduced into the outer layer of the foam, the foam and/or any incorporated materials can also be subjected to one or more forms of mechanical processing during and/or after formation. For example, the surface coating or capping layer may be subjected to embossing, pressing, stamping, planing, milling or other processing in order to add texture to the capping layer that simulates a natural “wood grain” feel as suggested in FIG. 8C.

### Eighth Embodiment

An eighth embodiment of a composite article according to the invention provides improved resistance to biological degradation in function or appearance. Although the basic product configuration may be similar to that described above in connection with the previous embodiments, the eighth embodiment will incorporate one or more compositions, particularly those that are or may become exposed to the environment, that include higher filling levels and/or concentrations of one or more biocidal agents or biocides. Typically the selected biocides will be those having demonstrated efficacy against organisms that would tend to decompose the wood and/or polymeric components of the composite article or simply those organisms that will tend to blemish or degrade the appearance of the affected surfaces in some manner, e.g., mildew or black algae forming on wetted surfaces.

The biocides may be introduced as liquids or particles including, for example, relatively insoluble polymeric nanoparticles which can be introduced into the compositions as suspensions, emulsions or dry powders. Those biocides distributed or otherwise introduced into one or more of the compositions may also act as a diluent to improve the volumetric distribution of the biocide(s) as the small particle or nanoparticles containing the biocide(s) and/or other additives, throughout the composite. Providing a plurality of biocides on separate insoluble nanoparticles can more effectively maintain separation between the active compounds and, in appropriate instances, can improve the stability of the biocide(s) and prolong their biocidal effectiveness by reducing mutual negative interactions between the biocide(s) and/or other components.

The biocides may be selected in consideration of their compatibility with the primary polymeric component(s), the polymers used in forming the nanoparticles (if any), the compatibility of the biocides, the solubility characteristics of the biocide(s) in the composition, other characteristics of the biocide including, for example, porosity, release rate, and toxicity; and complications (if any) that the use of such a biocide or combination of biocides would introduce into the manufacture of the composite articles. If nanoparticles are utilized, as a general rule the more highly branched polymers will tend to be more useful in forming less dense and more porous polymers that will, in turn, exhibit higher biocide release rates than particles forms form predominately linear polymers. Accordingly, polymers that are particularly useful for forming nanoparticles for distributing biocides throughout a WPC include, but are not limited to, polyvinylpyridine, polymethacrylate, polystyrene, polyvinylpyridine/styrene copolymers, polyesters, polyethylene, polypropylene, polyvinylchloride and blends thereof. Further, each of these homopolymers may be blended with acrylic acid or other suitable compound.

The biocide(s) may also be selected according to the target organism(s) to which exposure would be reasonably expected in the intended application of the composite article, stability at the temperature ranges and pH ranges anticipated during manufacture and/or use. As used herein, the term “biocide” is intended to encompass any compound or substance that tends to kill or inhibit the growth of one or more microorganisms and/or invertebrates, including, for example, molds, slime molds, fungi, bacteria, insects and arachnids. Accordingly, insecticides, fungicides and bactericides are each an example of a biocide. More specific classes of biocides include, but are not limited to, chlorinated hydrocarbons, organometallics, halogen-releasing compounds, metallic salts, organic sulfur compounds, compounds and phenolics. More specific examples of biocidal compounds include, without limitation, copper naphthenate, copper oxide, zinc naphthenate, quaternary ammonium salts, pentachlorophenol, tebuconazole (TEB), chlorothalonil (CTL), chlorpyrifos, isothiazolones, propiconazole, other triazoles, pyrethroids, and other insecticides, imidichloprid and oxine copper. Additional inorganic preservatives and biocides include, for example, boric acid, sodium borate salts, zinc borate, copper salts, zinc salts and combinations and mixtures thereof.

As will be appreciated by those skilled in the art, the polymeric nanoparticle technique may be used for distributing additives other than biocides. In particular, certain flame retardants and/or smoke suppressants may be introduced into one or more of the compositions used to form the composite articles by incorporating the active ingredient into a suitably porous nanoparticle. For example, fire retarding chemicals, water repellants, colorants, UV inhibitors and adhesive catalysts can be incorporated into such particles. As will be appreciated, the nature of the additive and the primary polymeric component(s) of the WPC will determine which polymers are most suitable for the incorporation and distribution of such additives. For example, flame suppressing compounds such as borax/boric acid, guanylurea phosphate-boric acid, dicyandiamide phosphoric acid formaldehyde and diethyl-N,N-bis(2-hydroxyethyl)aminomethyl phosphate may be incorporated into nanoparticles formed from polyvinylpyridine or polyvinylchloride.

Testing

The impact of the addition of WUCS material in WPC articles was examined in a series of sample articles. In a first trial, various quantities of WUCS (14 inch (6.4 mm) chop, 16 μm fiber, E-glass having a nominal 10% moisture content) or DUCS as reinforcing fibers (“RF”) were combined with wood flour (“WF”), (fresh 40 mesh pine) and a polymer, either polypropylene (PP) having a melt flow index (“MFI”) of about 5 or HDPE, to produce various compositions that were formed into plank boards. Ten samples where then cut from each of the plank boards for testing. Additional samples were prepared using 1-2% of a coupling agent selected from POLYBOND® 3029 (maleated HDPE) (available from Crompton) and FUSABOND® 100D (maleated LLPE) (available from DuPont). The samples cut from the plank boards fromed from the various compositions were then tested according to ASTM 709 to example their relative flexural properties.

The sample compositions prepared in the first trial were compounded according to TABLE 1.

TABLE 1
TRIAL 1 - Polypropylene

| Sample | | | WUCS |
|---|---|---|---|
| Composition | PP:WF:WUCS | WUCS | (Chop Length) |
| Number | (Dry Weight) | (Moisture %) | (in/mm) |
| 1 | 50:50:0 | na | na |
| 2 | 50:40:10 | ≈10 | 0.25/6.4 |
| 3 | 40:40:20 | ≈10 | 0.25/6.4 |
| 4 | 50:40:10 | ≈15 | 0.25/6.4 |
| 5 | 80:0:20 | ≈10 | 0.25/6.4 |
| 6 | 50:40:10 | ≈10 | 0.125/3.2 |
| 7 | 50:50:0 | na | na |

The sample compositions prepared in the second trial were compounded according to TABLE 2.

TABLE 2
TRIAL 2 - HDPE

| Sample | | | Coupling |
|---|---|---|---|
| Composition | HDPE:WF:RF | Coupling | Agent |
| Number | (Dry Weight) | Agent | Quantity |
| 1 | 50:50:0¹ | na | na |
| 2 | 40:50:10¹ | 3029 | 1 |
| 3 | 40:40:20¹ | 3029 | 1 |
| 4 | 40:30:30¹ | 3029 | 1 |
| 5 | 34:40:20² | 3029 | 1 |
| 6 | 34:40:20² | 3029 | 2 |
| 7 | 40:40:20¹ | 100D | 1 |
| 8 | 50:50:0 | na | na |

¹WUCS - ¼ inch chop, 10% moisture
²DUCS - ¼ inch chop, dry and 4% lubricant

The data generated from the samples showed that relative to the control sample (those with no added WUCS or DUCS), the addition of 20% and 30% WUCS resulted in 34% and 45% percent increases in the Young's Modulus of the samples. Similiarly, the combination of 20% DUCS and at least 1% coupling agent in the HDPE samples achieved as much as a 75% increase in the Young's Modulus when compared with the contriol samples. It is expected that additional development of the size composition provided on the WUCS and/or the use of coupling agents would tend to reduce the difference in the Young's Modulus between the WUCS and DUCS compositions.

Although the invention has been described in the context of particular composite articles and component materials, those skilled in the art will appreciate that the inventive methods and structures may be adapted for a wider range of polymeric compositions, additives, structures and applications. Example embodiments of the invention have been disclosed herein and, although specific terms are employed, they are used and are to be interpreted in a generic and descriptive sense only and not as limiting the invention to the embodiments disclosed. Accordingly, it will be understood by those skilled in the art that various changes in form and details of the disclosed compositions, articles and methods may be made without departing from the spirit and scope of the invention as set forth in the following claims. In particular, those skilled in the art will appreciate that various compositions and structures described with respect to one embodiment may be combined with complementary compositions and structures described with respect to a different embodiment to form a new composite article in accord with the disclosed invention.

We claim:

1. A method of manufacturing a reinforced composite article comprising:
preparing a first composition including a first polymeric component and a first reinforcing component;
preparing a second composition including a second polymeric component;
preparing a third composition including a third polymeric component and an additive;
coextruding the first, second and third compositions to form a composite article wherein
the first composition forms a primary structural frame having a first longitudinal cavity,
the second composition substantially fills the first longitudinal cavity, and
the third composition forms a surface layer on a major surface of the primary structural frame.

2. The method of manufacturing a reinforced composite article according to claim 1, wherein:
the first reinforcing component is fiberglass;
the second composition includes a filler selected from the group consisting of wood flour, wood fibers, calcium carbonate, talc, magnesium hydroxide and gypsum; and
the additive includes at least one component selected from a group consisting of UV stabilizers, color stabilizers, IR reflectors, fire retardants, smoke suppressors, lubricants, pigments, biocides, and dyes.

3. The method of manufacturing a reinforced composite article according to claim 1, wherein:
the first composition is substantially free of wood products and the first reinforcing component is fiberglass;
the second composition is substantially free of wood products and includes a filler selected from the group consisting of calcium carbonate, talc, magnesium hydroxide and gypsum; and
the third composition is substantially free of wood products and includes an additive selected from a group consisting of UV stabilizers, color stabilizers, IR reflectors, fire retardants, smoke suppressors, lubricants, pigments and dyes.

4. The method of manufacturing a reinforced composite article according to claim 1, wherein:
the first reinforcing component includes wet use chopped strand (WUCS) fiberglass having a moisture content of at least about 5 wt %.

5. The method of manufacturing a reinforced composite article according to claim 1, wherein:
the first reinforcing component is fiberglass;
the second composition includes a blowing agent whereby as the second composition is extruded it forms a polymeric foam filling the first longitudinal cavity; and
the additive includes at least one component selected from a group consisting of UV stabilizers, color stabilizers, IR reflectors, fire retardants, smoke suppressors, lubricants, wear resistors, biocides, friction modifiers, pigments and dyes.

6. The method of manufacturing a reinforced composite article according to claim 5, wherein:
the third composition includes a fire retardant, the composition and concentration of the fire retardant being sufficient to allow the reinforced composite article to qualify as fire-rated by a national standards organization.

7. The method of manufacturing a reinforced composite article according to claim 1, wherein:
the first reinforcing component includes wet use chopped strand (WUCS) fiberglass having a moisture content of at least about 5 wt %.

8. The method of manufacturing a reinforced composite article according to claim 7, wherein:
the first composition includes a moisture scavenger.

9. The method of manufacturing a reinforced composite article according to claim 7, wherein:
the first composition includes gypsum as a moisture scavenger.

10. The method of manufacturing a reinforced composite article according to claim 1, wherein:
the surface layer encompasses the primary structural frame and the second composition.

11. The method of manufacturing a reinforced composite article according to claim 1, wherein:
the surface layer is substantially free of wood products.

12. The method of manufacturing a reinforced composite article according to claim 1, further comprising:
introducing foreign material into an exterior portion of the surface layer.

13. The method of manufacturing a reinforced composite article according to claim 12, wherein the foreign material includes one or more components selected from a group consisting of wood fibers, wood flour, natural fibers, clay, fillers, polyolefins, copolymers, glass fibers, mineral fibers, dyes, pigments and colorants.

14. The method of manufacturing a reinforced composite article according to claim 13, wherein the foreign material is incorporated into the surface layer to form an elongated pattern of alternating light and dark colored regions in a manner simulating a natural wood grain appearance.

15. The method of manufacturing a reinforced composite article according to claim 1, further comprising:
modifying an exposed surface of the surface layer to form a texture.

16. The method of manufacturing a reinforced composite article according to claim 15, wherein:
modifying the exposed surface of the surface layer includes at least one process selected from embossing, stamping, pressing milling, grinding, planing and drilling.

17. The method of manufacturing a reinforced composite article according to claim 16, exposed surface of the surface layer is modified to form ridges simulating a natural wood grain texture.

18. A method of manufacturing a reinforced composite article comprising:
preparing a structural composition including a first polymeric component and a first reinforcing component;
preparing a coating composition including a second polymeric component and an additive;
coextruding the structural composition and the coating composition to form a composite product including a primary structural frame formed from the structural composition with the coating composition being provided as a layer on a major structural surface of the primary structural frame.

19. A method of manufacturing a reinforced composite article according to claim 18, further comprising:
injecting a filling composition into longitudinal cavities formed in the primary structural frame.

20. A method of manufacturing a reinforced composite article according to claim 19, wherein:
the filling composition expands upon injection to form a polymeric foam.

21. The method of manufacturing a reinforced composite article according to claim 18, wherein:
the coating composition covers all exterior surfaces of the primary structural frame.

22. The method of manufacturing a reinforced composite article according to claim 18, wherein:
one major surface of the primary structural frame is substantially free from the coating composition.

23. A method of manufacturing a reinforced composite article comprising:
preparing a first composition including a first polymeric component and a first reinforcing component;
preparing a second composition including a second polymeric component;
preparing a third composition including a third polymeric component and an additive;
coextruding the first, second and third compositions to form a composite article wherein
the first composition forms a primary structural element,
the second composition is a polymeric foam that encompasses the primary structural element, and
the third composition forms a surface layer on a major surface of the polymeric foam.

24. The method of manufacturing a reinforced composite article according to claim 23, wherein:
the first reinforcing component is fiberglass;
the second composition includes a filler selected from the group consisting of wood flour, wood fibers, calcium carbonate, talc, magnesium hydroxide and gypsum; and
the additive includes at least one component selected from a group consisting of UV stabilizers, color stabilizers, IR reflectors, fire retardants, smoke suppressors, lubricants, pigments, biocides, and dyes.

25. The method of manufacturing a reinforced composite article according to claim 23, further comprising:
modifying an exposed surface of the surface layer to form a texture.

26. The method of manufacturing a reinforced composite article according to claim 25, wherein:
modifying the exposed surface of the surface layer includes at least one process selected from embossing, stamping, pressing milling, grinding, planing and drilling.

27. A method of manufacturing a reinforced composite article comprising:
preparing a first composition including a first polymeric component, a reinforcing fiber and a blowing agent;
preparing a second composition including a second polymeric component and an additive;
coextruding the first and second compositions to form a composite article wherein
the first composition forms a polymeric foam that acts as a primary structural element, and
the second composition forms a surface layer on a major surface of the polymeric foam.

28. The method of manufacturing a reinforced composite article according to claim 27, wherein:
the reinforcing fiber is fiberglass;
the additive includes at least one component selected from a group consisting of UV stabilizers, color stabilizers, IR reflectors, fire retardants, smoke suppressors, lubricants, wear resistors, friction modifiers, biocides, pigments and dyes.

29. The method of manufacturing a reinforced composite article according to claim 27, wherein:
the second composition further includes a fire retardant, the composition and concentration of the fire retardant being sufficient to allow the reinforced composite article to qualify as fire-rated by a national standards organization.

30. The method of manufacturing a reinforced composite article according to claim 28, further comprising:
adding the reinforcing fiber to the first composition as wet use chopped strand (WUCS) fiberglass having a moisture content of at least 5 wt %.

31. The method of manufacturing a reinforced composite article according to claim 30, wherein:
the first composition includes a moisture scavenger.

32. A reinforced composite article comprising:
an elongated primary structural frame formed from a first polymeric composition incorporating reinforcing fibers and having a first longitudinal recess;
a second polymeric composition filling the longitudinal recess; and
a third polymeric composition forming a capping layer on a major surface of the primary structural frame.

33. The reinforced composite article according to claim 32, wherein:
the reinforcing fibers in the first polymeric composition include fiberglass fibers;
the second polymeric composition includes a filler selected from a group consisting of wood flour and wood fibers; and
a third polymeric composition includes a UV stabilizer.

34. The reinforced composite article according to claim 32, wherein:
the second polymeric composition is a foam.

35. The reinforced composite article according to claim 33, wherein:
the third polymeric composition includes reinforcing fibers.

36. The reinforced composite article according to claim 33, wherein:
the reinforcing fibers in the third polymeric composition include fiberglass fibers.

37. The reinforced composite article according to claim 32, wherein:
the primary structural frame includes first and second major surface elements, first and second minor surface elements arranged between the major surface elements and an internal longitudinal internal strut extending between the first and second major surface elements.

38. The reinforced composite article according to claim 37, further comprising:
a plurality of internal longitudinal internal struts defining a plurality of longitudinal cavities.

39. The reinforced composite article according to claim 38, wherein:
each of the plurality of longitudinal cavities are filled with the second polymeric composition.

40. The reinforced composite article according to claim 39, wherein:
the second polymeric composition is a polymeric foam.

41. The reinforced composite article according to claim 39, wherein:
the second polymeric composition is a polymeric foam incorporating reinforcing fibers.

42. The reinforced composite article according to claim 39, wherein:
the second polymeric composition is a polymeric foam having an average cell size of less than 100 μm.

43. The reinforced composite article according to claim 37, wherein:
the capping layer of the third polymeric composition covers substantially all of the first major surface element.

44. The reinforced composite article according to claim 37, wherein:
the capping layer of the third polymeric composition covers substantially all of the first major surface element and at least one minor surface element.

45. The reinforced composite article according to claim 37, wherein:
the capping layer of the third polymeric composition covers substantially all of the major and minor surface elements.
